(19) United States
(12) Patent Application Publication
(10) Pub. No.: US 2009/0100290 A1
(43) Pub. Date: Apr. 16, 2009

(54) MEMORY CONTROLLER, NONVOLATILE MEMORY DEVICE, NONVOLATILE MEMORY SYSTEM, AND DATA WRITING METHOD

(75) Inventors: Masahiro Nakanishi, Kyoto (JP); Masayuki Toyama, Osaka (JP); Manabu Inoue, Osaka (JP); Hirofumi Nakagaki, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/064,469

(22) PCT Filed: Aug. 9, 2006
(86) PCT No.: PCT/JP2006/315725

§ 371 Date: May 23, 2008

(30) Foreign Application Priority Data
Aug. 22, 2005 (JP) 2005-239472

(51) Int. Cl. G06F 11/20; G06F 12/16

(52) U.S. Cl. 714/5; 714/E11.084

(57) ABSTRACT

A nonvolatile memory device comprises a nonvolatile memory and a memory controller. The nonvolatile memory includes the same memory cells striding over a plurality of pages. A page information instruction part has the page structure information of the nonvolatile memory. According to this information, a related page identification part identifies a page (related page) in which the data may change. The relation data stored in the related page are temporarily stored into a save memory before an error occurs, and if an error exists, these relation data are used to repair the data that have changed. By this method, in a memory device using a nonvolatile memory including the same memory cells striding over a plurality of pages, even if an error occurs during data writing, the error is repaired and the reliability can be ensured.

### TECHNICAL FIELD

The present invention relates to a nonvolatile memory device having a rewritable nonvolatile memory, a memory controller for controlling the storage device, a nonvolatile memory system, and a data writing method.

### BACKGROUND ART

Demand for nonvolatile memory devices having a rewritable nonvolatile main storage memory is expanding mainly on semiconductor memory cards. The memory card has a flash memory as a nonvolatile memory and a memory controller for controlling the flash memory. In response to reading and writing instructions from an access device such as a digital still camera and a personal computer main body, the memory controller controls the reading and writing to the flash memory. Since the flash memory has larger variation in characteristics of memory cells than volatile memories such as RAMs, a write error occurs relatively often. Therefore, in a memory card having a nonvolatile memory therein, substitute processing of replacing the storage area in which a write error occurs with another storage area is carried out (Patent document 1). Herein, a flash memory such as a single-level NAND flash memory in which each memory cell is closed within 1 page is typically used as the nonvolatile memory.

A multi-level NAND flash memory holds great promise as a low-cost flash memory and has a high possibility to become the main current of a main storage memory of the memory card. Patent document 2 discloses a technique of improved page structure of the multi-level NAND flash memory to realize high-speed access. In a conventional flash memory of the single-level memory, one memory cell holds data of a certain bit in one page. On the contrary, in the multi-level NAND flash memory, each memory cell is composed of multiple pages, for example, striding over two pages, namely, holds data of multiple bits.

FIGS. 1 to 3 are configuration views showing a nonvolatile memory in which each memory cell is configured striding over multiple pages like the multi-level NAND flash memory. In FIGS. 1 to 3, the same group number (GN) is assigned to two pages containing data held in one memory cell. A non-hatched page is defined as a first page and a hatched page is defined as a second page.

For example, in the multi-level NAND flash memory shown in FIG. 1, a pair of an even number page and an odd number page composes one memory cell. Pages with the same group number represented as GN in this figure are a pair of pages which shares one memory cell. In each pair of pages, a page of low-order address is defined as a first page and a page of high-order address (hatched page) is defined as a second page. In FIG. 1, the first page is adjacent to the second page. However, in FIGS. 2 and 3, the first page is separated from the second page. This separation intends to reduce an effect (disturb) on data stored in the other page by writing into one page.

However, in a case where one memory cell is configured striding over two pages, when an error occurs during writing into one page, data stored in the other page disadvantageously changes. This problem will be described below referring to FIGS. 4 to 6.

FIG. 4 is a characteristic chart showing voltage distribution of a memory cell of the multi-level NAND flash memory shown in FIGS. 1 to 3. This memory cell stores information of 2 bits therein. A horizontal axis represents a voltage V obtained from the memory cell and a vertical axis represents a probability P that the voltage is obtained.

From the left, codes “11”, “10”, “00”, “01” are assigned to four distributions in FIG. 4, respectively. A right digit (bit) of each code corresponds to the first page and a left digit (bit) of each code corresponds to the second page. In an erased state, a state of each memory cell is “11”. When data is written into the first page from this state, if the data is normally written, the state of each memory cell remains to be “11” or shifts from “11” into “10”. Thereafter, when data is written into the second page side, if the data is normally written, the state of each memory cell remains to be “11” or shifts from “11” into “01”, or remains to be “10” or shifts from “10” into “00”.

FIG. 5 is a characteristic chart showing a state where data could be normally written into the memory cell. In FIG. 5, it is assumed that information of “01” as a target value is written by writing data into the first page and second page. In a writing process, first, the state becomes “11” by writing data into the first page and then, the state becomes “01” by writing data into the second page.

FIG. 6 is a characteristic chart showing a state where data could not be normally written into the memory cell. FIG. 6 shows that, in writing data into the second page, during shifting from a “11” state into a “01” state, the state of the voltage applied to the memory cell becomes a “10” state due to any trouble such as voltage change in the flash memory. Furthermore, there is a case where the state of the voltage applied to the memory cell becomes “00” state, hereinafter, such trouble is referred to as “flash trouble”. In writing data into the second page, the power is turned off when the state of the voltage applied to the memory cell reaches “10” or “00” state during shifting from “11” state into “01” state, and thus, the state may become “10” or “00” state. Hereinafter, such trouble is referred to as “power shutdown”.

In a case of the memory card, since power is typically supplied from an access device side, when the power of the access device is turned off carelessly during writing of data or the memory card is forcibly pulled out of the access device, power shutdown occurs.

Patent document 1: Japanese Unexamined Patent Publication No. 2003-76615

Patent document 2: Japanese Unexamined Patent Publication No. 2001-93288

### DISCLOSURE OF INVENTION

### Problems to be Solved by the Invention

System problems in the case of applying the multi-level NAND flash memory shown in FIG. 3 to a conventional nonvolatile memory system will be described. First, referring to FIGS. 7A and 7B, conventional error restoration processing in the event that a multi-level NAND flash memory is used and flash trouble occurs will be described. FIG. 7A shows a state where data is sequentially written into a physical block PB10 from a buffer on a left end of FIG. 7A as shown by A, B, C.

As shown in FIG. 7A, in a certain physical block, for example in a physical block PB10, it is assumed that flash trouble occurs while data is written into a page 17 as the second page of a group GN7. Here, a star sign represents a trouble. Since the group GN7 is composed of pages 11 and 17, data stored in the page 11 may change.

FIG. 7B is an operational explanatory view showing error restoration processing at the occurrence of flash trouble. In conventional error restoration processing, data stored in pages 0 to 16 of the physical block PB10 is copied to another physical block, for example, corresponding pages of PB5, and data to be stored in the page 17 of the PB, namely, data at logical addresses LA68 to 71 is retried to be written into the page 17 of the PB5. In a case of power shutdown, when the next power is turned on subsequently, new data is written from the page 17 again. Also in this case, data recorded in the pages 0 to 16 is copied in corresponding pages of the PB5.

However, when data stored in the page 11 of the PB10 changes, the data is not repaired in a conventional nonvolatile memory device, and thus wrong data is continuously used. In an event that the data is important data such as file system, a fatal problem that reading from the nonvolatile memory device cannot be performed may occur. In other words, when the error restoration processing disclosed in Patent document 1 is applied to the multi-level NAND flash memory disclosed in Patent document 2, disadvantageously, reliability is remarkably lowered.

Then, in consideration of the above-mentioned problem, an object of the present invention is to provide a reliable memory controller, nonvolatile memory device, nonvolatile memory system and data writing method which can restore the error that, due to an error at writing into a predetermined page, data stored in the other page composing the same memory cell with the predetermined page changes.

### Means to Solve the Problems

To solve the problems, a memory controller according to the present invention is a memory controller for writing data given from outside into a nonvolatile memory which is composed of a plurality of pages and in which each memory cell holds data of a plurality of pages composing a group therein and for reading data from the nonvolatile memory comprising: an error restoration part for restoring an error occurring in data stored in another page belonging to the same group as an error occurrence page with a write error, wherein said error restoration part, given that a page which belongs to the same group as a current page to which data is written and stores data therein is a related page, reads related data stored in said related page, temporarily stores the related data in a save area prior to writing of the data, and restores an error using the related data at an occurrence of the error.

Said memory controller may comprise: an error page identification part for identifying, when an error occurs during writing data in a certain page in said nonvolatile memory, a page in which the error occurs, wherein said error page identification part includes: a power shutdown determination part for determining an occurrence of power shutdown; and a memory trouble determination part for determining an occurrence of trouble in said nonvolatile memory.

Said error restoration part may further comprise: a page information instruction part for outputting page information on pages composing the same group in said nonvolatile memory; a related page identification part for identifying a related page based on said current page and page information outputted from said page information instruction part; and a substitute and repair processing part for repairing data stored in said related page by using said related data at an occurrence of an error.

Said nonvolatile memory may be composed of a plurality of physical blocks, and said substitute and repair processing part may perform copy processing for copying data written into an errorless page in a physical block during writing to another invalid physical block in said nonvolatile memory, repair processing for rewriting related data which is miswritten and held in said save area into a repair page of said invalid physical block, and retry processing for rewriting miswritten data in the physical block into said invalid physical block.

Said nonvolatile memory may be composed of multiple physical blocks, said substitute and repair processing part may perform copy processing for copying data written into an errorless page in a physical block during writing to another invalid physical block in said nonvolatile memory and repair processing for rewriting related data which is miswritten and held in said save area into a repair page of said invalid physical block, and said error restoration part may save the related data in a nonvolatile storage area.

Said error restoration part may have a nonvolatile save memory which saves the related data therein.

Said save memory may be a nonvolatile RAM. Said nonvolatile RAM may be composed of any one of a ferroelectric memory (FeRAM), Magnetoresistive Random Access Memory (MRAM), Ovonics Unified Memory (OUM), and Resistive RAM (RRAM).

To solve the problems, a nonvolatile memory device according to the present invention is a nonvolatile memory device comprising: a nonvolatile memory composed of a plurality of pages in which each memory cell holds data of a plurality of pages composing a group therein; and a memory controller for writing data given from outside and for reading data from the nonvolatile memory, wherein said memory controller includes: an error restoration part for restoring an error occurring in data stored in another page belonging to the same group as an error occurrence page with a write error, and said error restoration part, given that a page which belongs to the same group as a current page to which data is written and stores data therein is a related page, reads related data stored in said related page, temporarily stores the related data in a save area prior to writing of the data, and restores an error using the related data at an occurrence of the error.

To solve the problems, a nonvolatile memory system according to the present invention is a nonvolatile memory system comprising: an access device; and a nonvolatile memory device, wherein said access device sends a write command and data to said nonvolatile memory device, and said nonvolatile memory device includes: a nonvolatile memory composed of a plurality of pages in which each memory cell holds data of a plurality of pages composing a group therein; and a memory controller for writing data given from outside and for reading data from the nonvolatile memory, said memory controller includes: an error restoration part for restoring an error occurring in data stored in another page belonging to the same group as an error occurrence page with a write error, and said error restoration part, given that a page which belongs to the same group as a current page to which data is written and stores data therein is a related page, reads related data stored in said related page, temporarily stores the related data in a save area prior to writing of the data, and restores an error using the related data at an occurrence of the error.

To solve the problems, a data writing method according to the present invention is a data writing method for writing data given from outside into a nonvolatile memory which is composed of a plurality of pages and in which each memory cell holds data of a plurality of pages composing a group therein, comprising a step of: restoring errors occurring in data stored in other pages belonging to the same group of an error page in which a writing error occurred, wherein said error restoration step includes, given that a page which belongs to the same group as a current page to which data is written and stores data therein is a related page, reading related data stored in said related page, temporarily storing the related data in a save area prior to writing of the data, and restoring an error using the related data at an occurrence of the error.

### EFFECTIVENESS OF THE INVENTION

According to the present invention, even when a specific error occurs in a memory in which a memory cell stores data of multiple pages therein, an error restoration part can restore the error. Thus, in a memory card using a multi-level NAND flash memory which will be major current of flash memory, as compared with the memory card using the conventional memory in which a memory cell stores data of one page therein, higher reliability can be ensured.

### BRIEF DESCRIPTION OF DRAWINGS

FIG. 1 is a configuration view showing a multi-level NAND nonvolatile memory.

FIG. 2 is a configuration view showing the multi-level NAND nonvolatile memory.

FIG. 3 is a configuration view showing the multi-level NAND nonvolatile memory.

FIG. 4 is a characteristic chart showing voltage distribution of a memory cell of a multi-level NAND flash memory.

FIG. 5 is a characteristic chart showing a state where data could be normally written into a memory cell.

FIG. 6 is a characteristic view showing a state where data could not be normally written into the memory cell.

FIG. 7A is a flowchart showing data write processing in normal processing in a conventional nonvolatile memory system.

FIG. 7B is a flowchart showing substitute processing in the normal processing in the conventional nonvolatile memory system.

FIG. 8A is a block diagram of a nonvolatile memory system in accordance with a first embodiment of the present invention.

FIG. 8B is a block diagram showing a detailed configuration of an error page identification part and error restoration part of the nonvolatile memory system in accordance with the embodiment of the present invention.

FIG. 9 is a view showing a configuration of a nonvolatile memory in accordance with the present embodiment.

FIG. 10 is an explanatory view showing a format of a physical block provided in a nonvolatile memory 110.

FIG. 11 is an explanatory view showing a format of a logical address LA.

FIG. 12 is an explanatory view showing a format of a physical area management table 141.

FIG. 13 is an explanatory view showing a format of a logical-physical conversion table 142.

FIG. 14 is an explanatory view showing a current block status table.

FIG. 15 is an address map showing a format of a page information table.

FIG. 16A is a flowchart showing contents of initialization processing and error restoration processing.

FIG. 16B is a flowchart showing contents of the initialization processing and error restoration processing.

FIG. 17A is an operational explanatory view showing error restoration processing at a time of the occurrence of flash trouble.

FIG. 17B is an operational explanatory view showing error restoration processing at the time of the occurrence of flash trouble.

FIG. 18 is a flowchart showing processing contents of a flash trouble determination part.

FIG. 19 is a flowchart showing processing contents of a related page identification part.

FIG. 20 is a flowchart showing processing contents of error restoration processing in normal processing.

FIG. 21 is a flowchart showing processing contents of power shutdown determination in the normal processing.

FIG. 22 is an operational explanatory view showing error restoration processing at a time of the occurrence of power shutdown.

FIG. 23A is a block diagram of a nonvolatile memory system in accordance with a second embodiment of the present invention.

FIG. 23B is a block diagram showing detailed configuration of an error page identification part and error restoration part of the nonvolatile memory system in accordance with the second embodiment of the present invention.

FIG. 24A is an operational explanatory view showing the error restoration processing at the time of the occurrence of flash trouble in the second embodiment of the present invention.

FIG. 24B is an operational explanatory view showing the error restoration processing at the time of the occurrence of flash trouble in the second embodiment of the present invention.

FIG. 25 is an operational explanatory view showing the error restoration processing at the time of the occurrence of power shutdown in the second embodiment of the present invention.

### EXPLANATION OF REFERENCE NUMERALS

100, 100A Nonvolatile memory device
101 Access device
110 Nonvolatile memory
120, 120A Memory controller
122 CPU
125 Buffer memory
126 Address management part
127 Read-write controller
128 Error page identification part
129, 161 Error restoration part
131 Current block status table
132 Power shutdown determination part
133 Flash trouble determination part
141 Physical area management table
142 Logical-physical conversion table
151 Substitute and repair processing part
152 Related page identification part
153 Page information instruction part
154 Page information table
155 Save memory

### BEST MODE FOR CARRYING OUT THE INVENTION

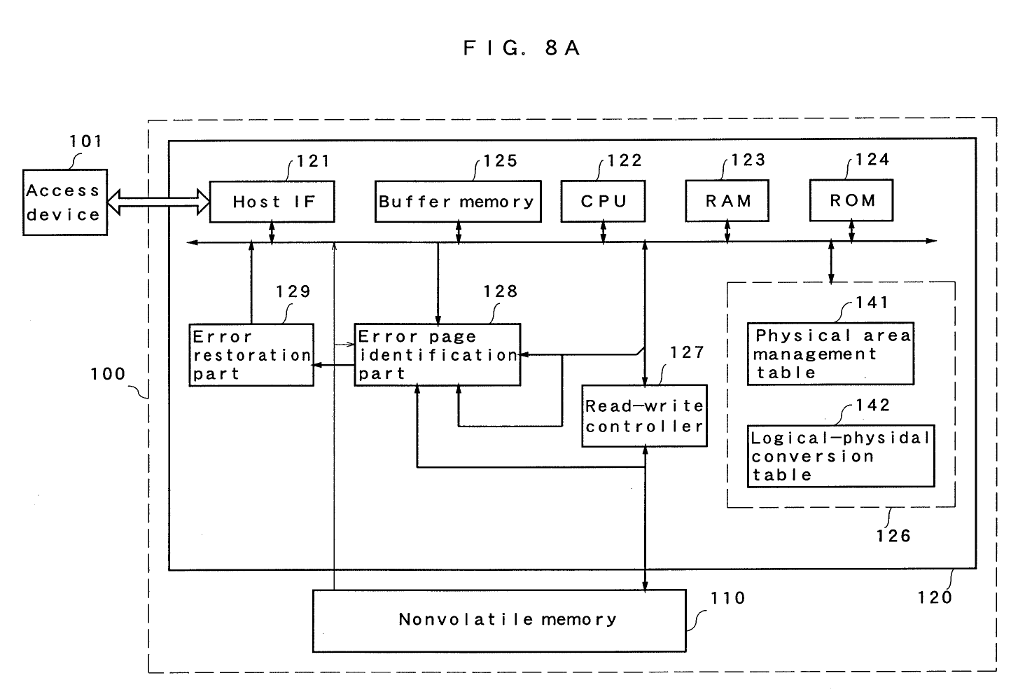

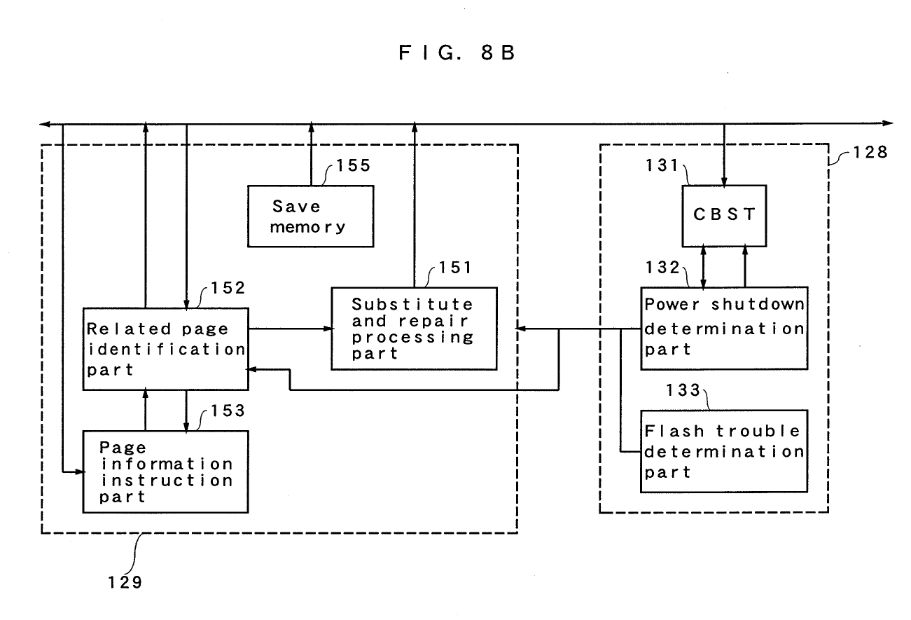

Hereinafter, a nonvolatile memory system in accordance with a first embodiment of the present invention will be described. FIG. 8 is a block diagram of the nonvolatile memory system. The nonvolatile memory system is composed of a nonvolatile memory device 100 and an access device 101.

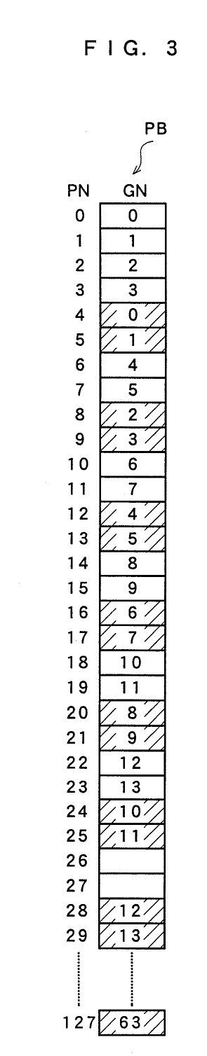

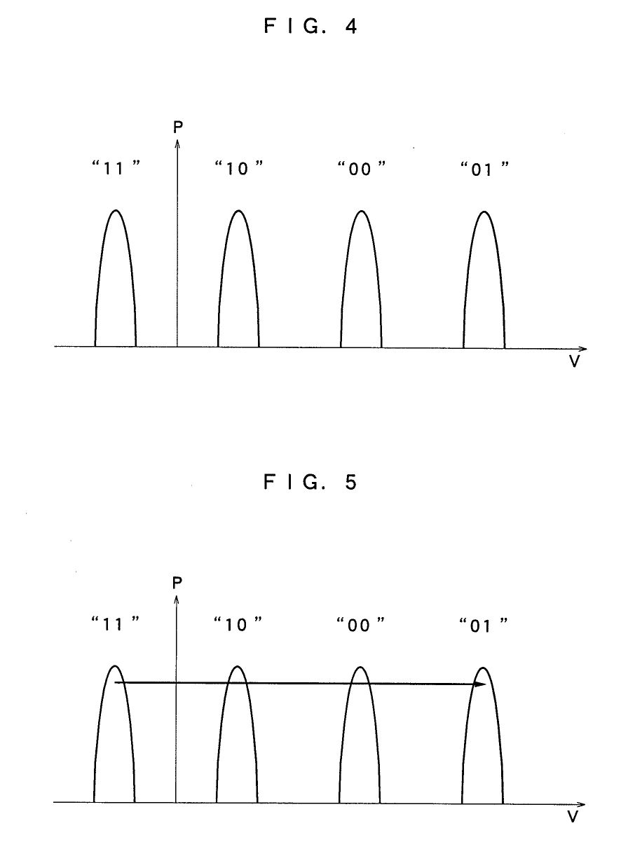

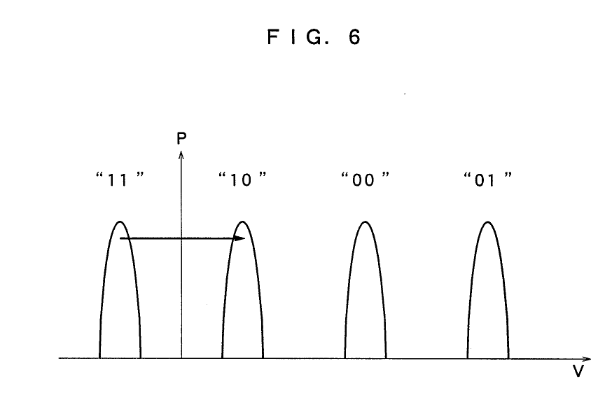

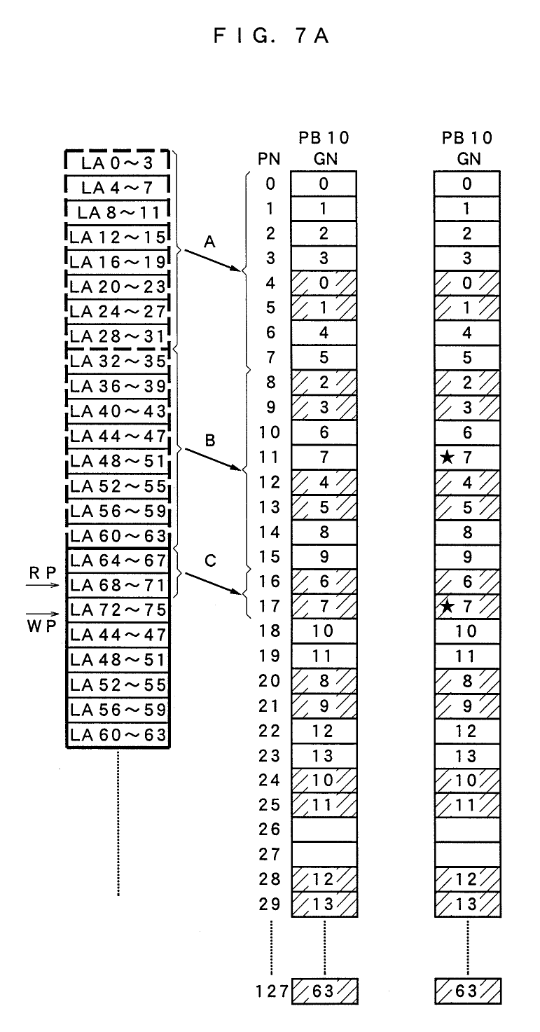

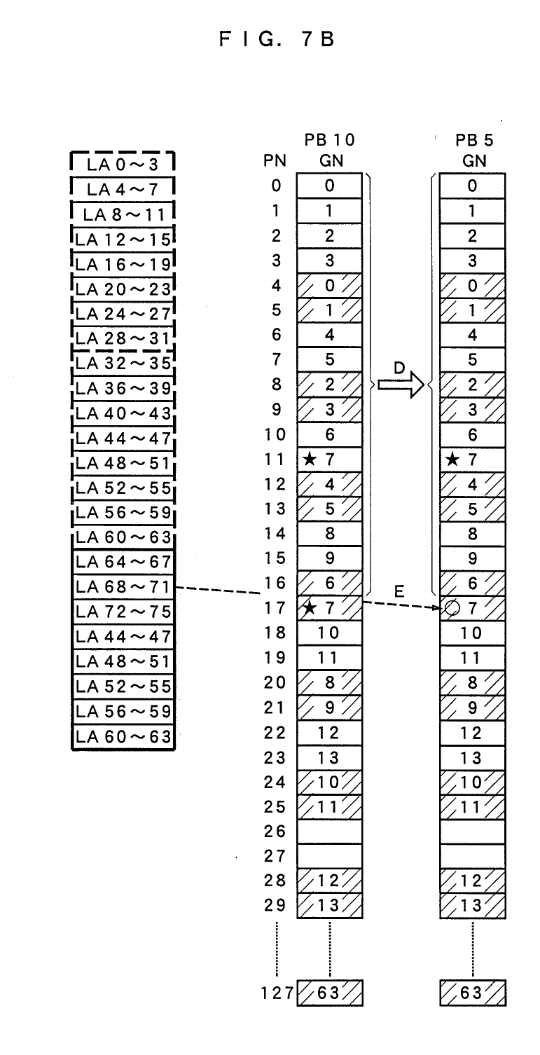

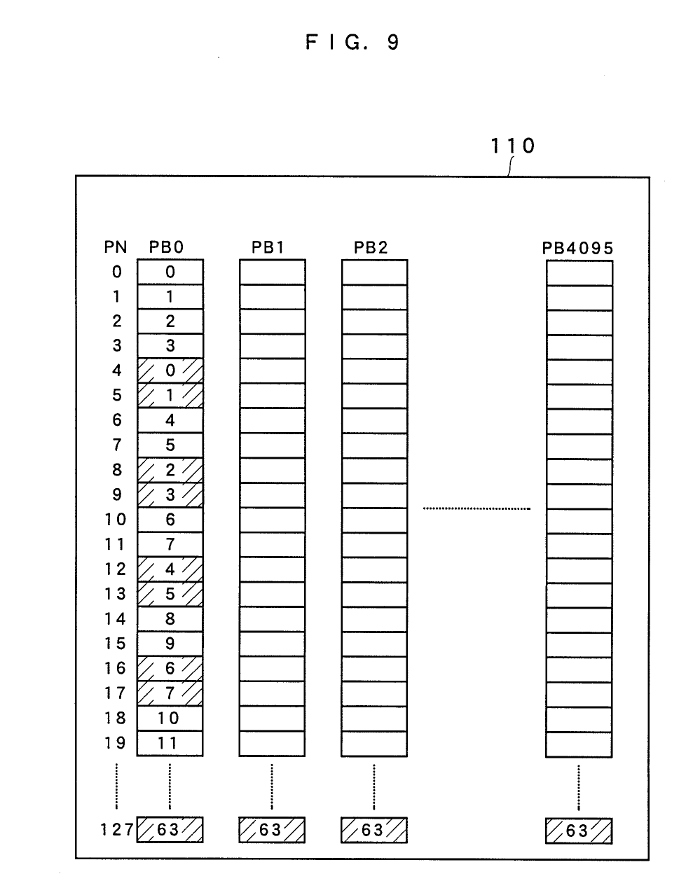

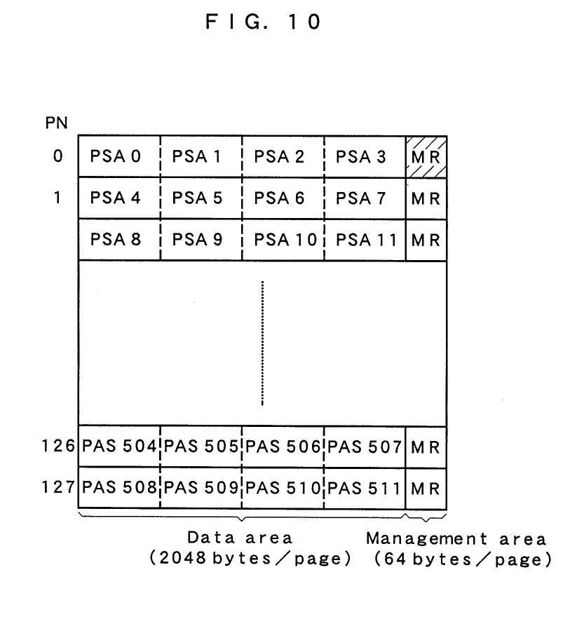

The nonvolatile memory device 100 has a nonvolatile memory 110 composed of a flash memory and has a memory controller 120. The nonvolatile memory 110 is a multi-level NAND flash memory in which one memory cell holds data striding over two pages. The nonvolatile memory 110 is composed of 4096 physical blocks PB0 to PB4095, for example, as shown in FIG. 9. Each physical block is an erasure unit of 128 pages. Each page is an access unit from the memory controller 120 and has storage capacity of 2112 bytes. Here, the memory has the same group structure as that shown in FIG. 3.

The access device 101 issues commands for reading and writing user data (hereinafter, merely referred to as data) to the nonvolatile memory device 100, transmits a logical address at which the data is stored, and transmits and receives the data. In response to the read and write commands from the access device 101, the memory controller 120 writes received data into the nonvolatile memory 110 and reads data from the nonvolatile memory 110 and outputs the read data.

Next, details of the memory controller 120 will be described. The memory controller 120 provided in the nonvolatile memory device 100 has a host IF 121 and a CPU 122 for controlling the whole of the memory controller 120. The memory controller 120 also has a RAM 123 as a work area of the CPU 122 and has a ROM 124 storing a program executed by the CPU 122 therein. The memory controller 120 also has a buffer memory 125 for temporarily storing data in accessing the nonvolatile memory 110 and an address management part 126 for designating an address in the nonvolatile memory 110. The buffer memory 125 is composed of a volatile memory such as SRAM having capacity of one page or of a nonvolatile memory such as FeRAM.

Based on the address designated by the address management part 126, a read-write controller 127 writes data into the nonvolatile memory 110 or reads data from the nonvolatile memory 110.

When an error occurs during writing data into a page in the nonvolatile memory 110, an error page identification part 128 transfers an error type flag to the error restoration part 129. The error type flag is a flag for identifying a physical address of the page (hereinafter referred to as an error page number) and an error type. The error page identification part 128, as shown in a detailed block diagram of FIG. 8B, has a current block status table (CBST in the figure) 131, a power shutdown determination part 132, and a flash trouble determination part 133.

The current block status table 131 is a table for storing a write state of the currently-accessed physical block therein. The current block status table 131 is composed of a nonvolatile RAM such as a ferroelectric memory (FeRAM), Magnetoresistive Random Access Memory (MRAM), Ovonics Unified Memory (OUM) or Resistive RAM (RRAM) and records a currently-written logical block address, physical block address, and the write state of each page.

The power shutdown determination part 132 determines occurrence state of power shutdown that is one of causes of error. Based on a current block status stored in the current block status table 131, a ready-busy flag transferred from the nonvolatile memory 110 after writing of data into the nonvolatile memory 110, and a current page number representing a physical address of the currently-written page which transferred from the address management part 126, the power shutdown determination part 132 identifies the error page number in which the error occurs. Then, the power shutdown determination part 132 transfers the error page number and error type flag to the error restoration part 129.

The flash trouble determination part 133 is a memory trouble determination part for determining trouble occurrence state in the flash memory as one of causes of error. Based on an error status transferred from the nonvolatile memory 110 after writing of data into the nonvolatile memory 110 and the current page number transferred from the address management part 126, the flash trouble determination part 133 identifies the error page number in which the error occurs and transfers the error page number and the error type flag to the error restoration part 129.

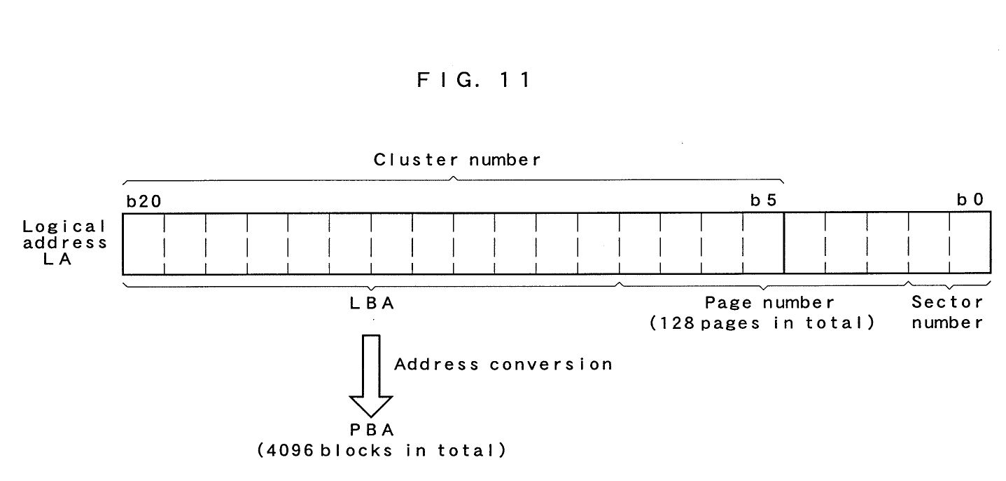

FIG. 10 shows a format of the physical block in the nonvolatile memory 110. As shown in this figure, one physical block is composed of 128 pages of page numbers (PN) 0 to 127. Each page is composed of a data area of four sectors and of a management area MR. One sector is composed of 512 bytes and one page is composed of four sectors of 2048 bytes. The management area MR is 64 bytes per page and has a logical block address and status flag corresponding to the page number. The status flag represents a valid block, invalid block, or bad block in the unit of physical blocks. In FIG. 10, physical location signs such as PSA0, PSA1, . . . , PSA511 are assigned from an upper left. PSA is an acronym of Physical Sector Address.

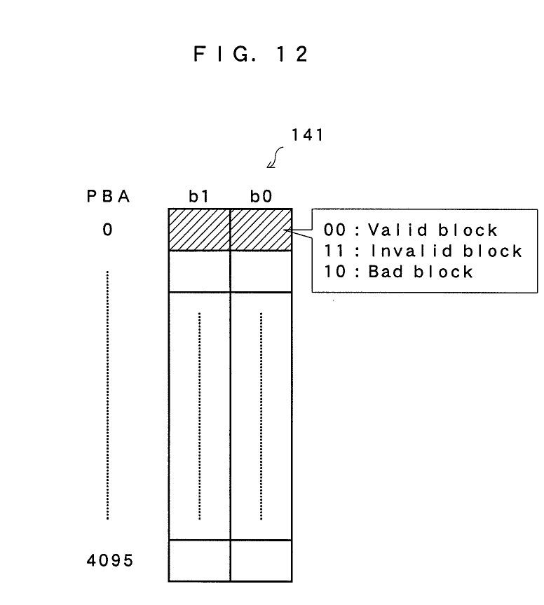

FIG. 11 is an explanatory view showing a format of a logical address LA. As shown in this figure, sector numbers, page numbers, and logical block address LBA are arranged in this order from a lower order bit and 12 bits corresponding to the logical block address LBA correspond to an object of address conversion, namely to an address of a logical-physical conversion table 142. Since sector size and cluster size which are defined by a file system of the access device 101 are 512 bytes and 16 kbytes, respectively, a LSB in a cluster number corresponds to a bit 5 (b5). Bits b8 to b2 of the logical address LA correspond to the page number.

The address management part 126 includes a physical area management table 141 and logical-physical conversion table 142. Referring to these tables, the address management part 126 performs so-called address management such as a selection of the physical block to which data transferred from the access device 101 is written, an instruction of the page to which data is written in the concerned physical block, namely, the current page number, and preread processing described later. The physical area management table 141 stores the status flag representing a state of the physical block that is an erasure unit in the nonvolatile memory 110, namely, showing whether or not valid data is stored therein. The logical-physical conversion table 142 is a table necessary for converting the logical address transferred from the access device 101 into the physical address in the nonvolatile memory 110.

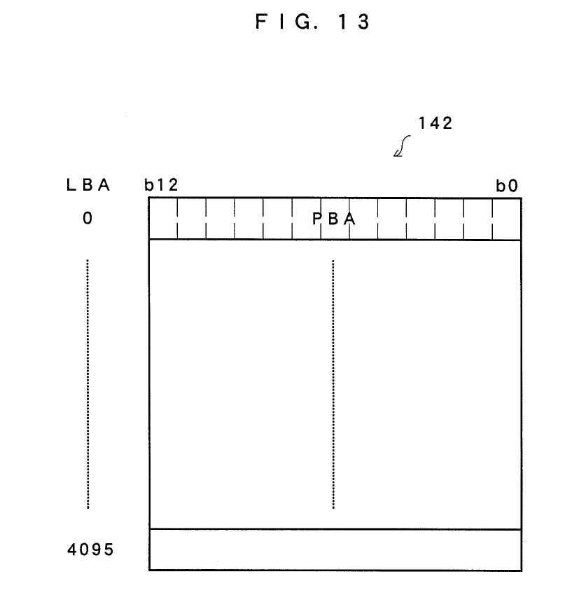

FIG. 12 shows a format of the physical area management table 141. As apparent from this figure, the address in the table 141 corresponds to the physical block address PBA in the nonvolatile memory 110 and the table stores the status flag of each physical block therein. As the status flag, a value 00 in a binary number represents a valid block which stores valid data therein, a value 11 represents an invalid block into which data is erased or written data is unnecessary, and a value 10 represents a bad block which cannot be used due to solid error on the memory cell.

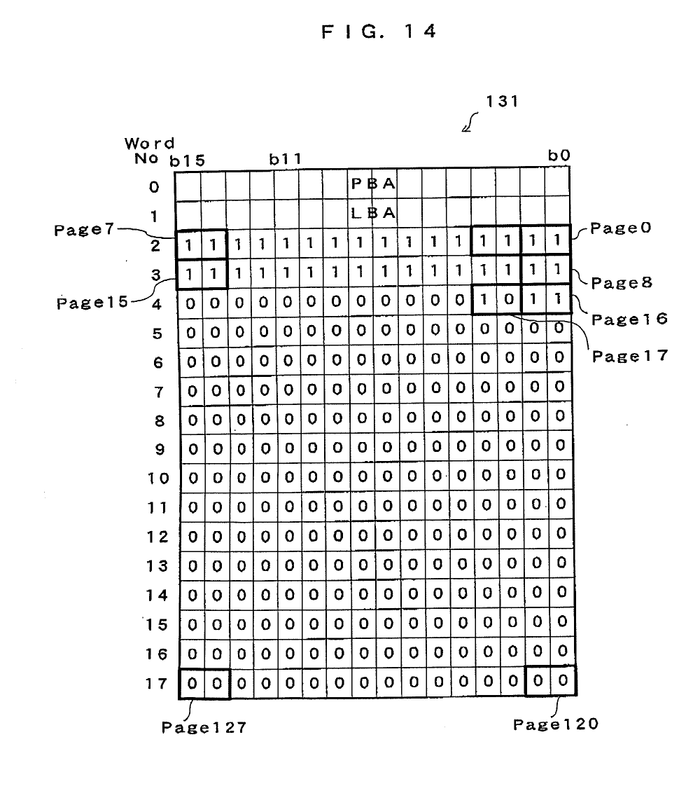

FIG. 13 shows a format of the logical-physical conversion table 142. The table 142 is a table for holding the physical block addresses PBA corresponding to each logical block addresses LBA, respectively.

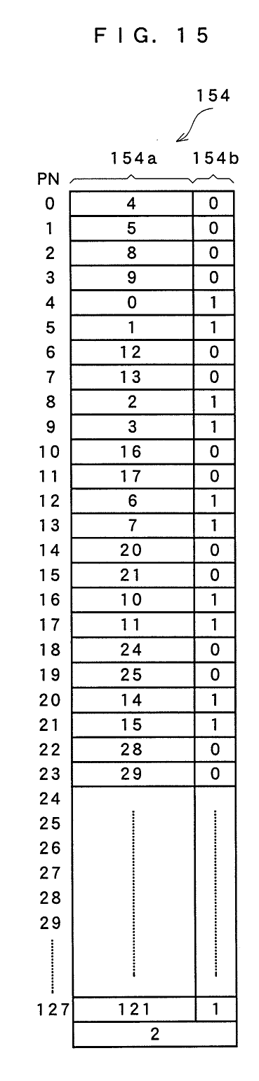

FIG. 14 shows a current block status table 131. The current block status table 131 is composed of 18 words and one word is composed of 16 bits. The physical block address PBA of 12 bits is temporarily stored in b11 to b0 of a word 0. The logical block address LBA is temporarily stored in b11 to b0 of a word 1. An area from a word 2 to a word 17 corresponds to a write state status area. An identification flag for identifying the write state of each page (page 0 to page 127) composing the current block is temporarily stored in this area. The identification flag is composed of 2 bits per page. Based on the current page number outputted by the address management part 126 and the ready-busy flag outputted by the nonvolatile memory 110, the CPU 122 sets the identification flag. A higher order bit is a bit which is set based on the current page number. A lower order bit is a bit which is set based on the ready-busy flag. The identification flag represents that data has not been written into the page in a case of the value 00 in binary number, that data is being written into the page in a case of the value 10, and that data is has been written into the page in a case of the value 11.

When the CPU 122 instructs the address management part 126 to obtain an invalid physical block as the current block according to a write command of the access device 101, the CPU 122 completely clears the current block status table 131. Then, the CPU 122 sets the physical block address PBA at the word 0 and the logical block address LBA at the word 1 and then, sets the identification flag according to write processing for each page of the current block.

The error restoration part 129, as shown in FIG. 8B, has a substitute and repair processing part 151, related page identification part 152, page information instruction part 153, and save memory 155.

Based on the error page number, the substitute and repair processing part 151 performs copy processing, retry processing, and repair processing. The copy processing is for copying data already stored in the physical block including an error occurrence page (a block of writing object) to the other erased block. The retry processing is for rewriting data which were tried to be written into the error page of the block of writing object into a page of the other erased block corresponding to the error page. Given that a repair page is another page composing the same memory cell as the error page, the repair processing instructs processing for writing repair data into a first page (related page) corresponding to the repair page of the erased block.

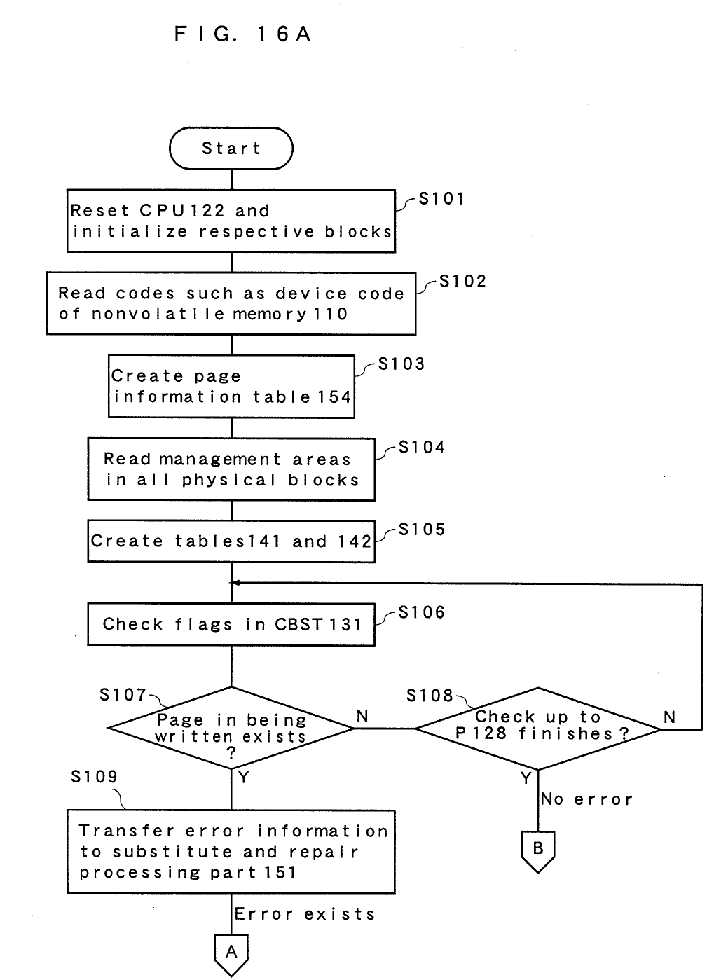

The page information instruction part 153 has a page information table 154. The table 154 is a table for storing page information of the page of data held in the memory cell. FIG. 15 is an address map showing a format of the page information table 154. The page information table 154 is composed of 129 words and leading 128 words are arranged from the page number (PN) 0 to 127. Page number relationship information 154a and page type information 154b are stored in each word. The page number relationship information 154a stores the other page number belonging to the same group therein. The page type information 154b stores a flag for identifying which the page number described as PN in this figure is a first page or a second page. Here, “0” denotes the first page and “1” denotes the second page. As described above, the first page means a page on a lower order address side than the second page.

The last word in the page information table 154 stores the number of pages of which one memory cell is composed, namely, 2 therein. The page information table 154 in FIG. 15 is a table for showing page structure of the multi-level NAND flash memory shown in FIG. 9 and its contents varies depending on the type of the multi-level NAND flash memory.

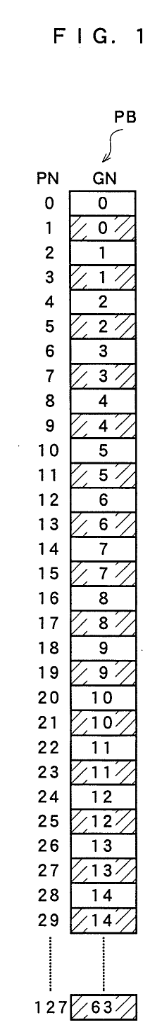

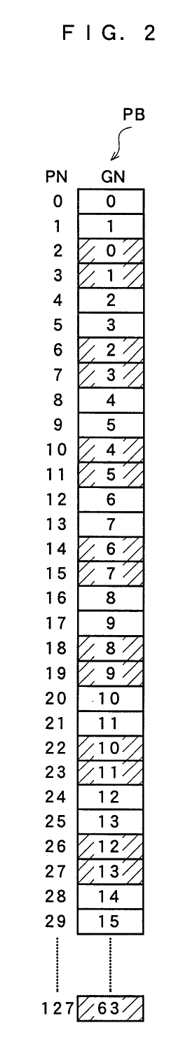

The page information table 154 is composed of a volatile RAM such as SRAM, or nonvolatile RAM or ROM such as a ferroelectric memory (FeRAM). In a case of the volatile RAM, in initialization processing at power-on, the CPU 122 may compose the page information table 154 in the SRAM or the like based on a device code read from the nonvolatile memory 110 by the CPU 122. As a specific configuration method, a table may be selectively transferred from the ROM 124 to the SRAM on the basis of the device code after the page information table is previously stored in the ROM 124 by device type. In a case of the multi-level NAND flash memory with relatively simple page structure as shown in FIG. 1, there is a relationship (regularity) between even number and odd number. Thus, the page information instruction part 153 need not have the page information table and can calculate the page number relationship information according to a bit operation on the basis of the device code. Specifically speaking, in a case of the multi-level NAND flash memory as shown in FIG. 1, the page number relationship information can be calculated according to an equation (1). Here, an operator is an exclusive OR operator.

$$Page number relationship information = page number \hat{} 0 \times 01 , \qquad ( 1 )$$

Where 0x represents a hexadecimal number.

The save memory 155 has storage capacity of one page and is used as a save area for data of the first page belonging to the same group of the second page when data is written in the second page of each group. In a case where this memory is composed of a nonvolatile RAM such as the ferroelectric memory (FeRAM), both the troubles of power shutdown and flash trouble can be addressed, thereby restoring the error. In a case where this memory is composed of a volatile RAM such as SRAM, only the flash trouble can be solved.

As described below using a flowchart, based on the current page number received from the address management part 126, the related page identification part 152 refers to the page information table in the page information instruction part 153 or executes calculation according to the equation 1 to determine a page number belonging to the same group. The repair processing of the substitute and repair processing part 151 repairs an error by using the error page number and error type flag which are received from the error page identification part 128, the related page number from the related page identification part 152, and related data temporarily stored in a save memory.

Hereinafter, operations of the nonvolatile memory device 100 will be described.

### [Initial State]

First, contents of the nonvolatile memory 110 and logical-physical conversion table 142 immediately after shipping will be described. In the nonvolatile memory 110, there are system area which stores system information such as the device code and security information therein and a normal area in which the user reads and writes data. Various information in the system area is written on the manufacturer's side before the shipping.

All good blocks in the normal area of the nonvolatile memory 110 after the shipping have been erased and the status flag and logical block address are set in the management area MR (hatched area in FIG. 10) of the leading page of the physical block. Since the status flag is in an initial state, the status flag has the value 11 (invalid block) or value 10 (bad block).

A value 0xFFF is set as the logical block address. The value 0xFFF does not mean that the physical address of the nonvolatile memory 110 is 0xFFF, but means that no physical address is set. Therefore, the physical block at the physical address 0xFFF in the nonvolatile memory 110 is an unusable physical block, and a logical address managed by the access device 101 designates a space smaller than 4096 addresses from the addresses 0x0000 to 0xFFF in the unit of 256 kbytes as the physical block size.

### [Initialization Processing at Power-on]

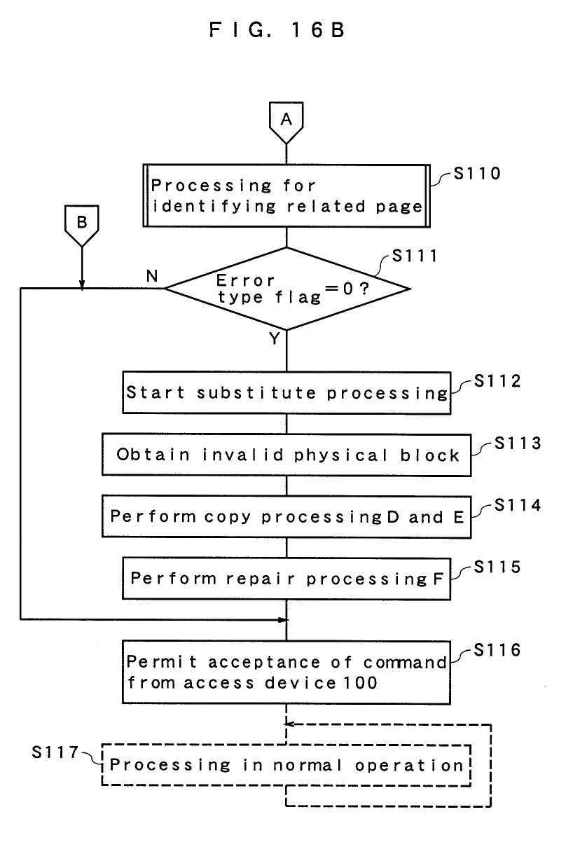

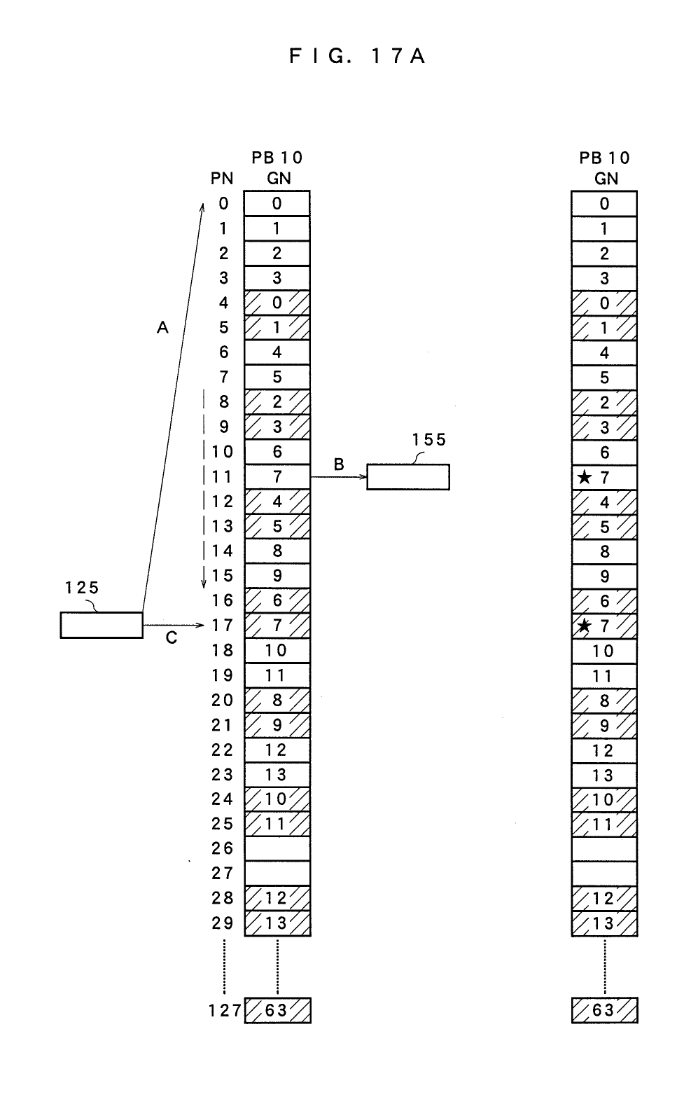

FIGS. 16A and 16B are flowcharts showing processing after power-on. When the power is on, first, the CPU 122 is reset and performs initialization processing based on a program stored in the ROM 124 (S101). In the initialization processing, first, the RAM 123 and the buffer memory 125 are completely cleared. The device code is read from the system area in the nonvolatile memory 110 via the read-write controller 127, and the type and capacity of the nonvolatile memory 110 are identified based on the device code (S102).

Next, based on the device code read from the nonvolatile memory 110, the page information table 154 is created in the page information instruction part 153 (S103). Alternatively, the page information instruction part 153 may find page structure information according to the arithmetic function (corresponding to the equation 1) that is based on the device code.

Next, the CPU 122 reads the management area of leading pages of all physical blocks in the nonvolatile memory 110 via the read-write controller 127 (S104). Then, the physical area management table 141 and the logical-physical conversion table 142 are created in the address management part 126 (S105).

Then, the CPU 122 checks whether or not an error due to power shutdown caused by a write operation before power-on occurs by checking the current block status table 131. Here, a case immediately after the shipping, namely, a case where a page in being written does not exist is described, and a case where the page in being written exists will be described later in detail. When the page in being written does not exist, the procedure proceeds from S107, S108 in the flowchart of FIG. 16A to S116 in FIG. 16B to be put into an acceptance permitted state for a command such as a read or write command sent from the access device 101.

After putting into the acceptance permitted state for the commands, in a case where the nonvolatile memory device 100 has not been formatted, the access device 101 formats the nonvolatile memory device 100 on the basis of a FAT file system to compose a logical address space. Then, the procedure proceeds to processing in a normal operation.

### [Processing in Normal Operation]

Next, processing in the normal operation after initialization will be described. Since the present invention intends to improve error restoration in write processing, here, only write processing will be described. Furthermore, since data is often written in units of clusters from the access device 101, for clarity of description, only writing in units of clusters will be described. Also in writing in units of clusters, data transfer permission control is performed between the access device 101 and the nonvolatile memory device 100 in units of sectors which are minimum write units.

First, the access device 101 transfers a write command of 16 kbytes (of one cluster) of the logical addresses LA0 to LA31 to the nonvolatile memory device 100. When the host IF 121 receives the write command, the host notifies the receipt to the CPU 122, and the CPU 122 writes data into the buffer memory 125 in the order starting from data of the logical address LA0.

Since capacity of the buffer memory 125 has capacity of one page (four sectors), the data of logical addresses LA0 to LA3 is written into the buffer memory 125. When the data of logical addresses LA0 to LA3 is temporarily stored in the buffer memory 125, the CPU 122 writes the data in the buffer memory 125 into the nonvolatile memory 110. When writing of the data into the nonvolatile memory 110 has finished, the CPU 122 issues transfer permission for next data to the access device 101 via the host IF 121. In this manner, the CPU 122 writes data in units of four sectors from the buffer memory 125 into the nonvolatile memory 110. When write processing of data of one cluster from the access device 101 has finished, the CPU 122 notifies that “the corresponding cluster has been normally written” to the access device 101 via the host IF 121.

In parallel with the above-mentioned operations, when the host IF 121 receives the write command from the access device 101, using the write command as a trigger, the CPU 122 instructs the address management part 126 to obtain one physical block to which data is written. The address management part 126 refers to the physical area management table 141, searches an invalid block in ascending order starting from a randomly selected address, and defines a firstly found invalid physical block, for example, PB10 as a physical block of writing target. This enables wear leveling that prevents certain blocks from being designated intensively as the block of the writing target. The CPU 122 transmits an erasure command for the PB10 to the nonvolatile memory 110 through the read-write controller 127 and writes data after erasure of the PB10.

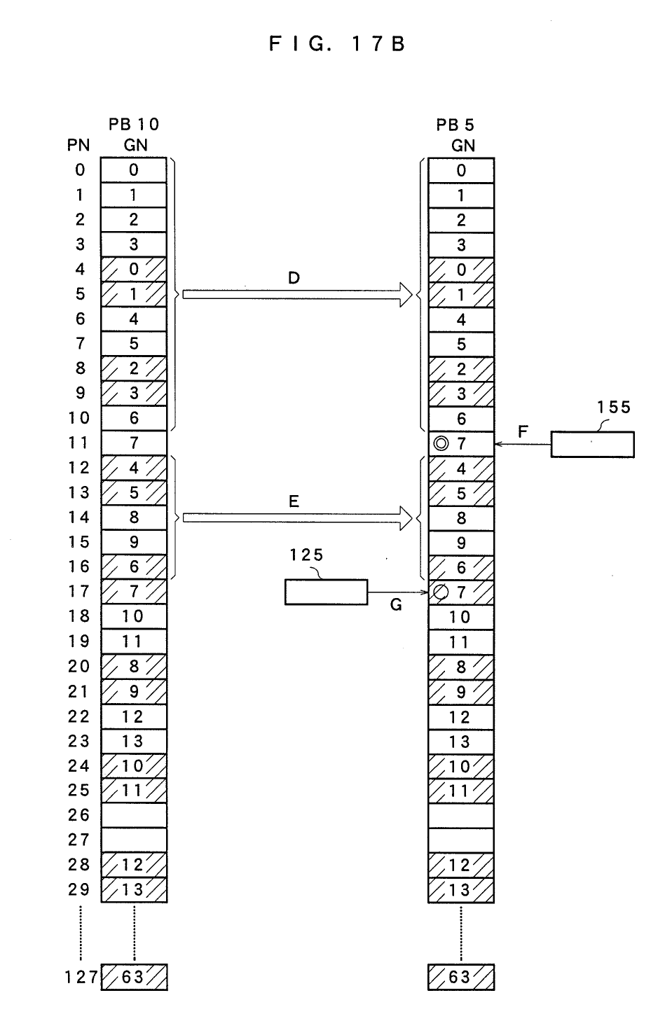

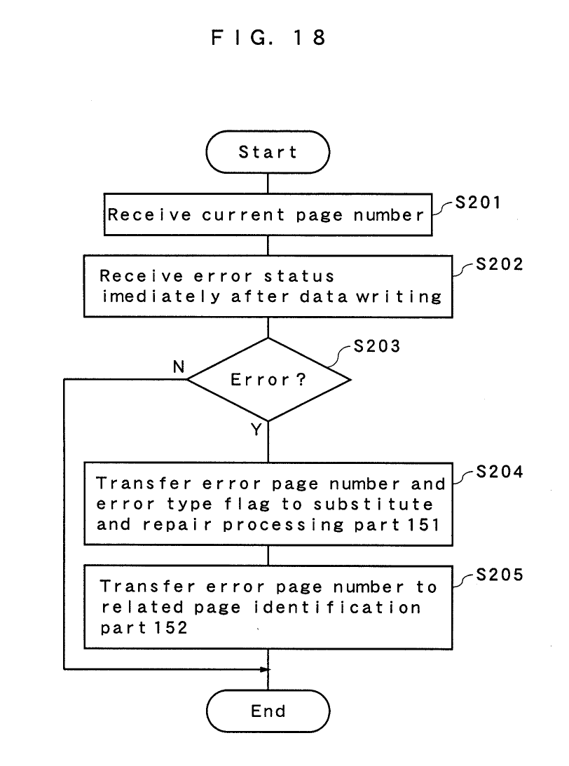

Next, a flow of writing the data temporarily stored in the buffer memory 125 into the physical block in the nonvolatile memory 110 will be described referring to FIG. 17A. The PB10 represents one physical block in the nonvolatile memory 110.

When data of four sectors, namely, one page is temporarily stored in the buffer memory 125, the CPU 122 performs write processing of data to the PB10. The CPU 122 transfers the data LA0 to LA3 stored in the buffer memory 125 to the read-write controller 127. In parallel with the operations, the address management part 126 refers to the logical address LA held by the CPU 122, defines the page number in the logical address format in FIG. 11 as the page number (current page number) to which data is written, and sequentially transfers it to the read-write controller 127, error page identification part 128, and the related page identification part 152.

The read-write controller 127 writes data into the corresponding page in the PB10 in the nonvolatile memory 110 (corresponding to an arrow A in FIG. 17A), and when writing finishes, the nonvolatile memory 110 puts the ready-busy flag into a ready state and notifies the fact to the error page identification part 128 and CPU 122. As a result of the notification, in the event that an error occurs and data cannot be normally written, the procedure proceeds to error restoration processing.

If the error does not occur, after receiving the ready-busy flag, the CPU 122 issues transfer permission for next data to the access device 101 via the host IF 121 and the access device 101 transfers data at the logical address LA4 and later.

In this manner, the data stored in the buffer memory 125 is written into the corresponding page in the PB10 in units of pages. When data of one cluster of the logical addresses LA0 to LA31 is stored in pages 0 to 7 in the PB10, the CPU 122 notifies that “the corresponding cluster has been normally written” to the access device 101 via the host IF 121.

In a case where the access device 101 continuously writes data of one cluster of logical addresses LA32 to LA63, the access device 101 performs the similar processing to store the data into pages 8 to 15 in the PB10. In the case where the access device 101 continuously writes data of one cluster at logical addresses LA64 to LA95, the access device 101 performs the above-mentioned series of processing to store the data in pages 16 to 23 into the PB10.

In a series of write processing, as described later, the CPU 122 temporarily stores data stored in the first page into the save memory 155 prior to writing into the second page. For example, in FIG. 17A, before processing of writing into the page 17 in the PB10 (an arrow C in FIG. 17A), the CPU 122 saves data stored in the page 11 in the PB10 in the save memory 155 (arrow B). In this case, the page 11 is the first page and the page 17 is the second page. The save memory 155 saves the data stored in the first page prior to each writing into the second page. The first page is referred to as a “related page” and the data stored in the first page is referred to as “related data”.

### [Error Restoration Processing in the Case of Flash Trouble]

Here, processing in a case where data could not be normally written into the page 17 in the PB10 due to flash trouble will be described referring to FIGS. 17 to 20.

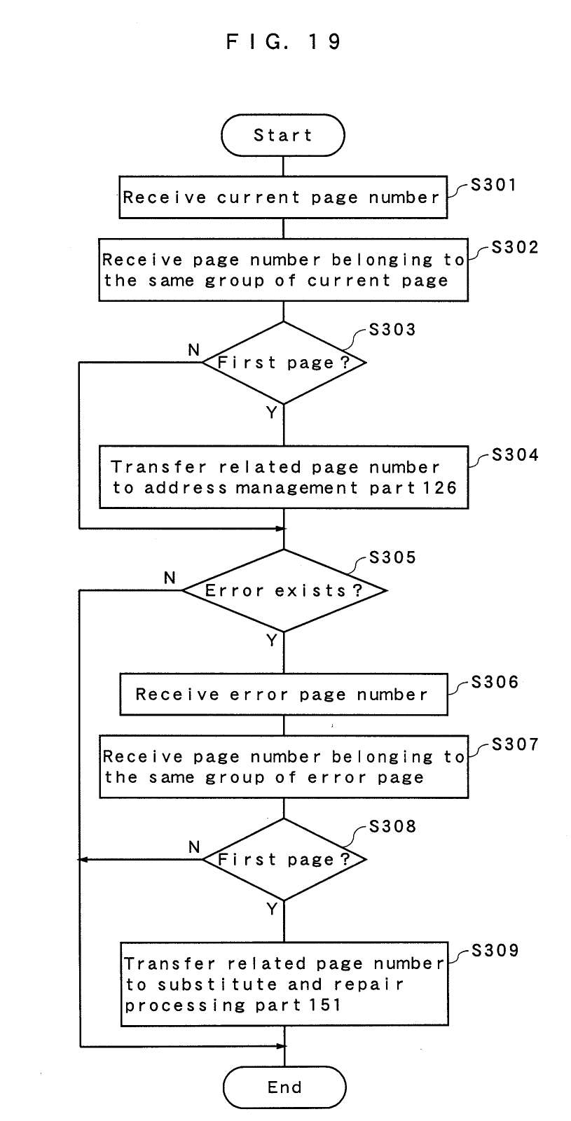

In FIG. 18, at the time of writing into the page 17 in the PB10, the flash trouble determination part 133 receives the current page number from the address management part 126 (S201). When the writing into the page 17 in the PB10 has finished, the nonvolatile memory 110 transfers an error status to the memory controller 120 and the flash trouble determination part 133 receives the error status (S202). The flash trouble determination part 133 checks the error status and when a flag representing an error occurrence is raised (S203), the flash trouble determination part 133 recognizes that flash trouble occurs during writing into the page 17 in the PB10. The flash trouble determination part 133 defines the page 17 as the error occurrence page, and sets the error page number (physical address) and error type flag to be a value 1 and transfers them to the substitute and repair processing part 151 (S204). The error page number is also transferred to the related page identification part 152 (S205). The value 0 of the error type flag represents an error due to power shutdown and the value 1 of the error type flag represents an error due to flash trouble.

Meanwhile, irrespective of the error occurrence, the address management part 126 transfers the current page number to the related page identification part 152 and the related page identification part 152 gives an instruction of preread processing (save processing) described later as necessary.

In a flowchart in FIG. 19, the related page identification part 152 receives the current page number transferred from the address management part 126 (S301) and transfers the current page number to the page information instruction part 153. By referring to the page number relationship information 154a of the page information table 154, the page information instruction part 153 transfers the page number belonging to the same group of the current page number to the related page identification part 152 (S302). For example, when the current page number is the page 17, the page 11 as the page number belonging to the same group is transferred to the related page identification part 152.

Next, based on the page type information 154b, it is determined whether or not the page number belonging to the same group is the first page (S303). If the page number is the first page (namely, the related page), the related page number is transferred to the address management part 126 (S304) and the address management part 126 is instructed to perform the preread processing described later. Whether the NAND flash memory is a single-level or multi-level NAND flash memory, data must be written from a side of the lower order address. Accordingly, when the current page number is the first page, the preread instruction is unnecessary.

The preread processing is for storing data stored in the related page transferred from the related page identification part 152 to the address management part 126 into the save memory 155 prior to writing into the current page. In this manner, data held in the save memory 155 as needed is referred to as related data, and using the related data, garbled data in the related page which is caused by the writing error in the current page is repaired. Repair processing will be described later.

After the processing relating to the above-mentioned preread instruction, it is determined whether or not an error occurred (S305). If no error exists, the processing finishes. Pages having an error are shown by a star sign in the right PB10 in FIG. 17A. If an error exists, the related page identification part 152 receives the error page number transferred from the error page identification part 128 (S306). The error page number is transferred to the page information instruction part 153. By referring to the page number relationship information 154a of the page information table 154, the page information instruction part 153 transfers the page number belonging to the same group of the error page number to the related page identification part 152 (S307). For example, when the error page number is the page 17, the page number 11 is transferred to the related page identification part 152.

Next, it is determined whether or not the page number belonging to the same group is the first page on the basis of the page type information 154b (S308). If the error page is the first page, repair processing is unnecessary. If the error page is the second page, data in the related page need to be repaired. For example, when the related page number is the page 11 and the error page number is the page 17, the related page number is transferred to the substitute and repair processing part 151 (S309) and control shifts to the substitute and repair processing part 151. In a case where S309 is not performed, namely, the related page identification part 152 does not transfer the related page to the substitute and repair processing part 151, the repair processing is not performed.

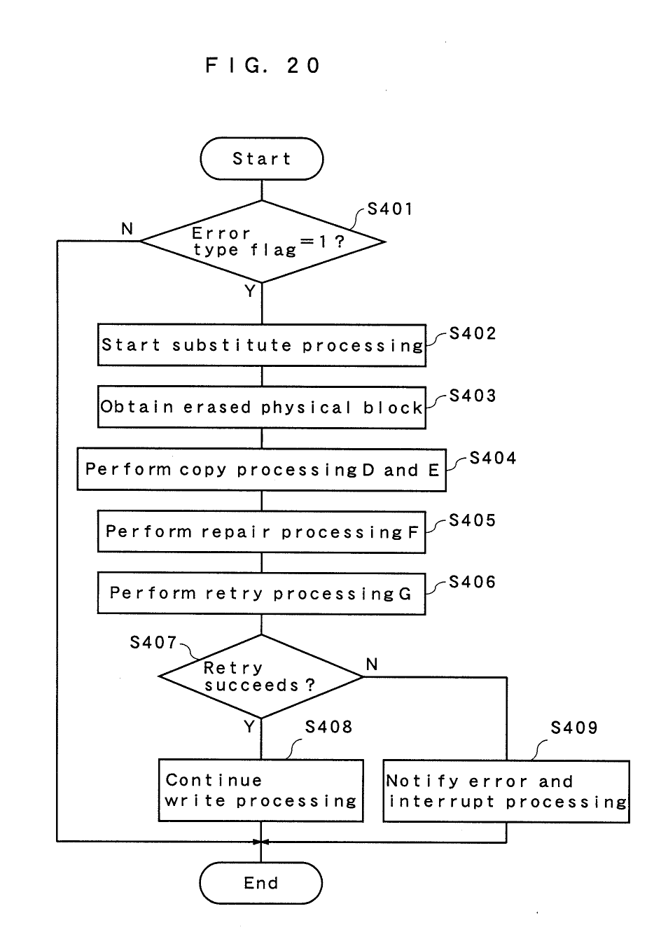

When the control shifts to the substitute and repair processing part 151, as shown in FIG. 20, it is determined whether or not the error type flag is 1 (S401). If the flag is not 1, the processing finishes. If the flag indicates 1, namely, the error due to flash trouble occurs, the procedure proceeds to S402 and the substitute and repair processing part 151 performs substitute processing (copy processing, repair processing, and retry processing) (S402).

The copy processing is for copying data written into the errorless page in the PB10 to another erased physical block (for example, PB5) in the error restoration processing in FIG. 17B. In the copy processing, the address management part 126 obtains the erased physical block PB5 as a block to which the data is copied first (S403). The substitute and repair processing part 151 performs copy processing for all pages except for the repair page (page 11) which are pages lower order addresses than the address of the error page number (S404). Here, since the error occurrence page is 17 and the repair page is 11, as shown by hollow arrows D and E pointing from the physical block PB10 to the physical block PB5, pages 0 to 10 and pages 12 to 16 are copied.

Next, at step S405, the repair processing is performed. The repair processing is for rewriting the related data temporarily stored in the save memory 155 into the related page. For example, in the error restoration processing in FIG. 17B, as shown by a broken line arrow F, the related data held in the save memory 155 is written into a page 11 (related page) in the physical block PB5.

In the error restoration processing in FIG. 17B, the retry processing is for rewriting data miswritten into the page 17 in the physical block PB10 into the page 17 in the physical block PB5 as shown by a broken line arrow G in FIG. 17B. In the retry processing, the substitute and repair processing part 151 performs the retry processing of the error occurrence page (S406). When writing succeeds (S407), writing of data into pages after the page 18 is continued (S408). When writing fails, the fact that “the corresponding cluster cannot be normally written” is notified to the access device (S409) and a rewrite command of the concerned cluster is required to be issued.

The above-mentioned substitute processing can restore the error caused by flash trouble. The address management part 126 sets the corresponding status flag in the physical area management table to be an invalid block so that the physical block PB10 can be erased to be available next.

### [Error Restoration Processing in the Case of Power Shutdown]

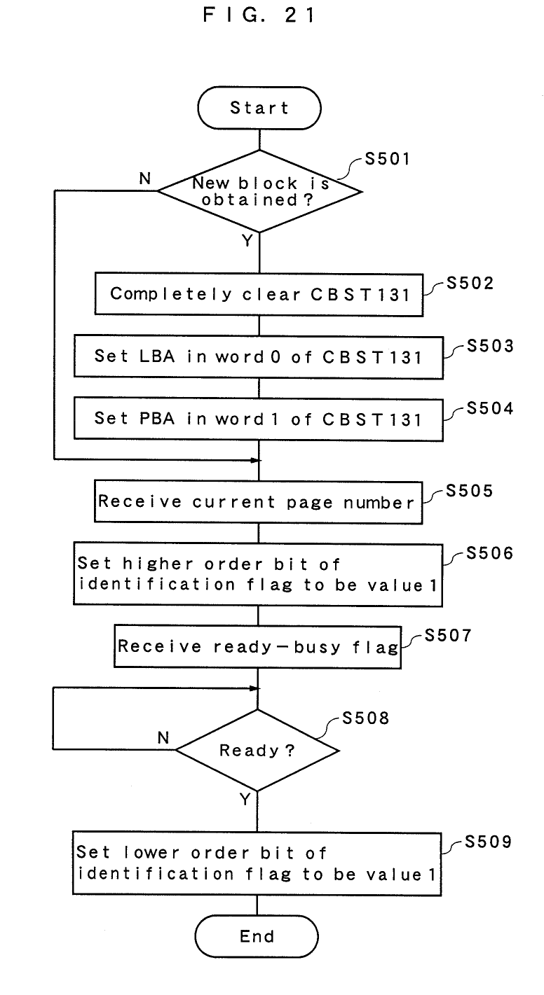

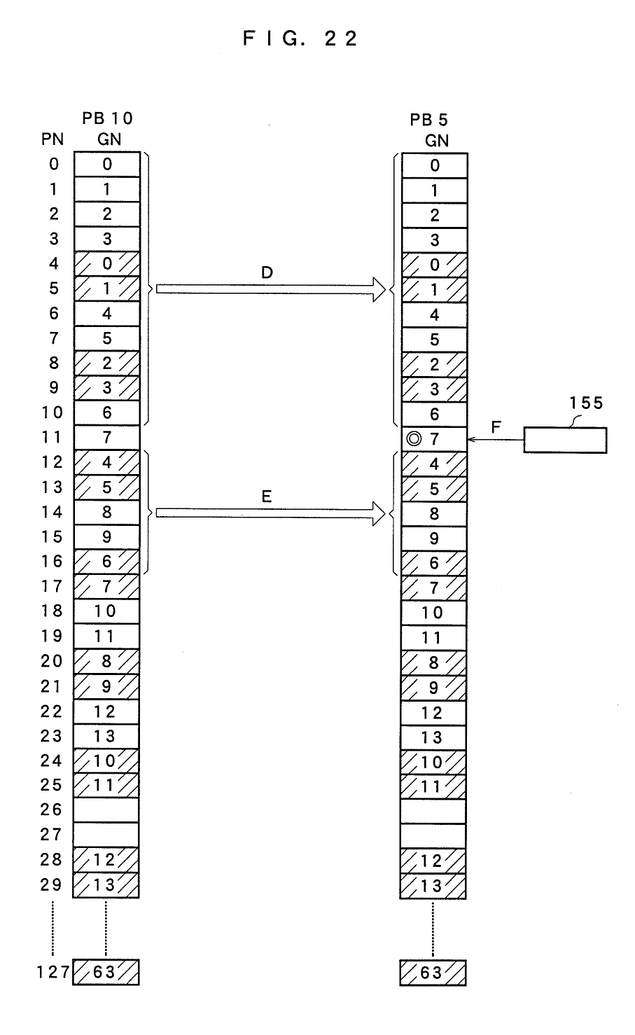

Next, error restoration processing in the case of power shutdown will be described referring to FIGS. 21 and 22. First, referring to FIG. 21, a flow of the power shutdown determination part 132 in processing in a normal operation will be described. Here, the normal processing refers to processing other than the initialization processing performed immediately after power-on, in other words, refers to processing performed after acceptance of commands from the access device 101. This flowchart includes initialization processing and update processing of the current block status table 131. In the initialization processing, in response to a write instruction sent from the access device 101, it is determined whether or not a new invalid physical block is obtained first (S501). If the block is obtained, the current block status table 131 is completely cleared (S502), the physical block address PBA10 is set to the word 0 of the current block status table 131 (S503), and the logical block address LBA is set to the word 1 of the current block status table 131 (S504).

Since then, whether the new invalid physical block is obtained or not, processing at S505 to S509 is performed in each writing into each page in the PB10. The power shutdown determination part 132 receives the current page number from the address management part 126 (S505), and when reading data temporarily stored in the buffer memory 125, sets the higher order bit of the identification flag in the write state corresponding to the current page to be the value 1 (S506). Immediately after data is written into the nonvolatile memory 110, the read-write controller 127 receives the ready-busy flag (S507). When the state is ready (S508), by setting the lower order bit of the identification flag corresponding to the current page to be the value 1 (S509) the fact that writing into the predetermined page has finished is recorded in the current block status table 131 as a history.

As described above, by recording the write state into each page in the current block status table 131, a page in being written at power shutdown can be identified in the initialization processing at power-on immediately after power shutdown. An example of the current block status table 131 shown in FIG. 14 shows that data has been written into the pages 0 to 16 and power shutdown occurs during writing into the page 17.

The case where initialization processing is performed after power shutdown occurs during writing into the page 17 will be described referring to FIG. 16A. The power shutdown determination part 132 checks the identification flag of the current block status table 131 (S106). When the page in being written exists (S107), the page is defined as the error occurrence page and the error page number and error type flag are transferred to the substitute and repair processing part 151 (S109).

When an error occurs, the procedure proceeds to FIG. 16B after the processing at S109 and processing for identifying the related page is performed (S110). This is described in the above-mentioned flowchart in FIG. 19. That is, when the page belonging to the same group is the first page (S308), the related page identification part 152 transfers the related page to the substitute and repair processing part 151 (S309). When the page belonging to the same group is not the first page, the related page identification part 152 does not transfer the related page to the substitute and repair processing part 151.

The substitute and repair processing part 151 checks the error type flag transferred from the error occurrence page identification part 128 (S111), and when a value is 0, namely, the error due to power shutdown is determined, error restoration is performed. FIG. 22 shows error restoration processing. The substitute and repair processing part 151 starts substitute processing (copy processing and repair processing) (S112). The substitute and repair processing part 151 obtains an invalid physical block, for example, PB5 as a block to which data is copied (S113). Next, the substitute and repair processing part 151 performs copy processing of pages (pages 0 to 16) at lower order addresses than the address of the error page number (page 17) (arrows D, E). Here, data in the related page (page 11) is not copied from the PB10. Finally, the substitute and repair processing part 151 obtains the related data from the save memory 155 and writes the data into the related page having the page number 11 (S115, an arrow F).

In the case of the error due to power shutdown, unlike the error due to flash trouble, the retry processing is not performed. Since concerning the cluster having the error, the CPU 122 does not notify that “the corresponding cluster has been normally written” to the access device 101, the retry processing is unnecessary. In addition, since data to be written into the error occurrence page (page 17) disappears due to power shutdown, the retry processing cannot be performed. Therefore, in the case of power shutdown, the copy processing of at least the cluster which is notified as having been normally written to the access device 101 only needs to be performed. In other words, it is sufficient to perform only the copy processing of the page at lower order address than the address of the error occurrence page (except for the related page) and the repair processing of the related page.

As described above, in the first embodiment of the present invention, since the error restoration part 129 performs the repair processing, the error specific to the nonvolatile memory 110 in which the same memory cell is composed striding over two pages, namely, the error that data stored in the first page changes due to the write error in the second page can be solved.

The nonvolatile memory system in accordance with the embodiment of the present invention can repair data in both cases of the flash trouble and power shutdown by adding the error restoration processing.

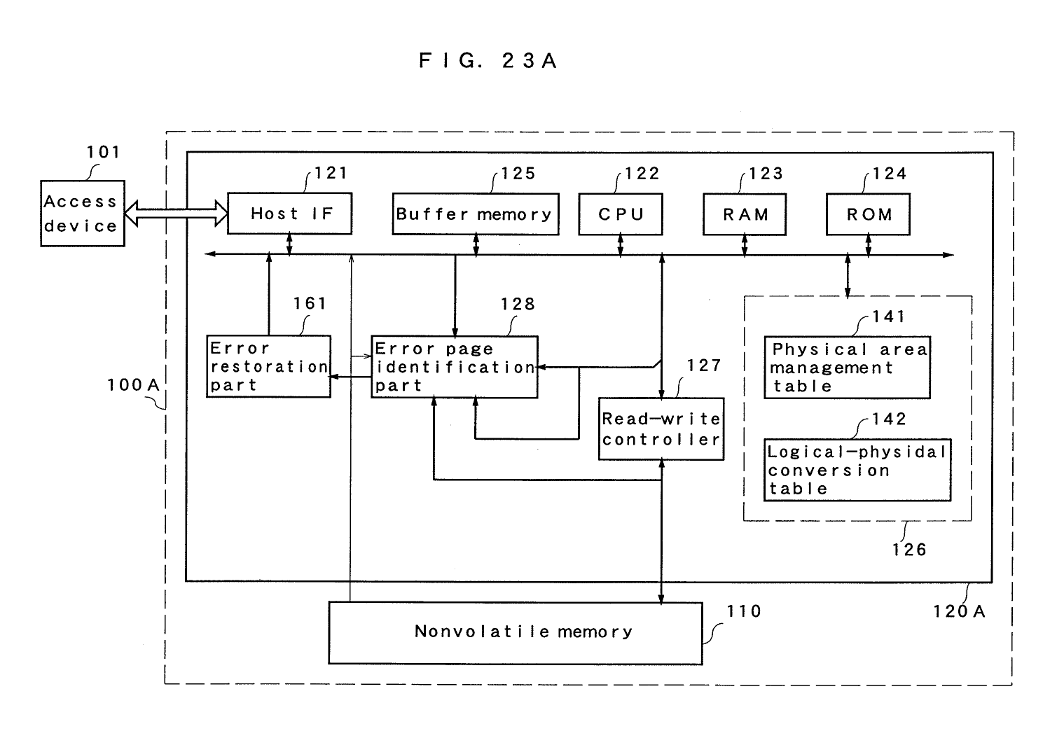

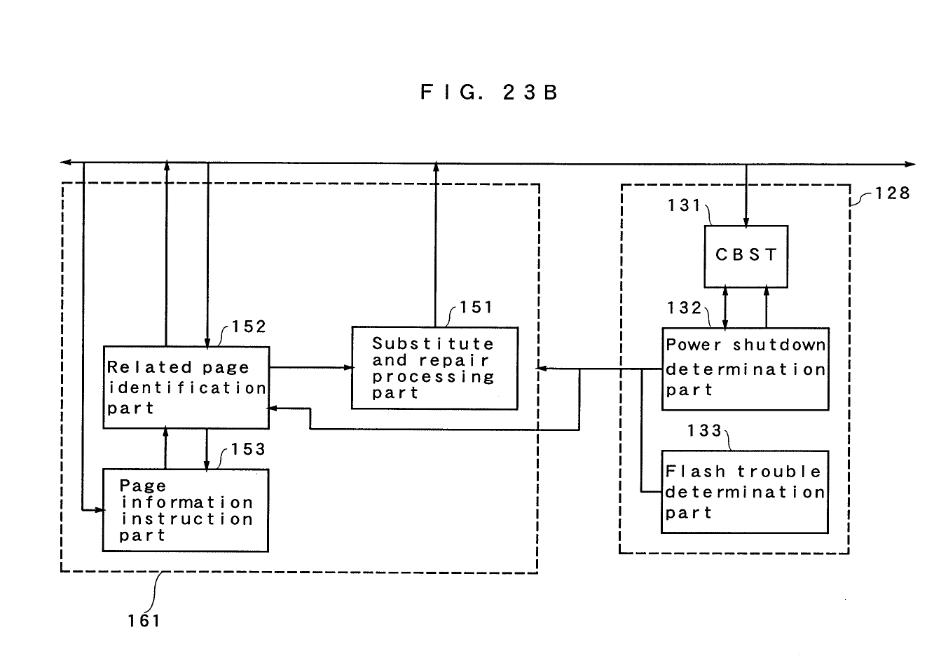

Next, a second embodiment of the present invention will be described. In the present embodiment, a part of an area in a nonvolatile memory is used as a save area in place of the save memory. FIGS. 23A, 23B are block diagrams in the second embodiment and the same reference numerals are assigned to the same parts as those in the first embodiment. In the present embodiment, a nonvolatile memory device 100A has a memory controller 120A and the nonvolatile memory 110 similar to the nonvolatile memory in the above-mentioned embodiment. The memory controller 120A has an error restoration part 161. The error restoration part 161, as shown in FIG. 23B, has no save memory 125 and other components are the same as those in the first embodiment. In the present embodiment, one physical block in the nonvolatile memory 110 is used as a save physical block in place of the save memory. The save physical block is arbitrarily selected from blank blocks with every saving. This realizes wear leveling that prevents certain blocks from being designated intensively as the block of the writing target. Although only a leading page of each physical block is used as the save area in the present embodiment, each page may be sequentially used as the save area. In the present embodiment, since the nonvolatile memory is used as the save memory, in both the cases of the errors due to flash trouble and power shutdown, data can be repaired.

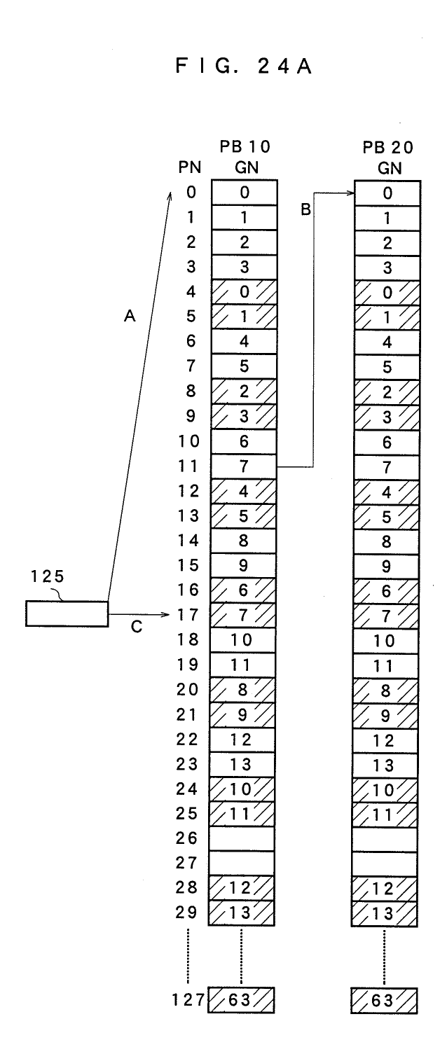

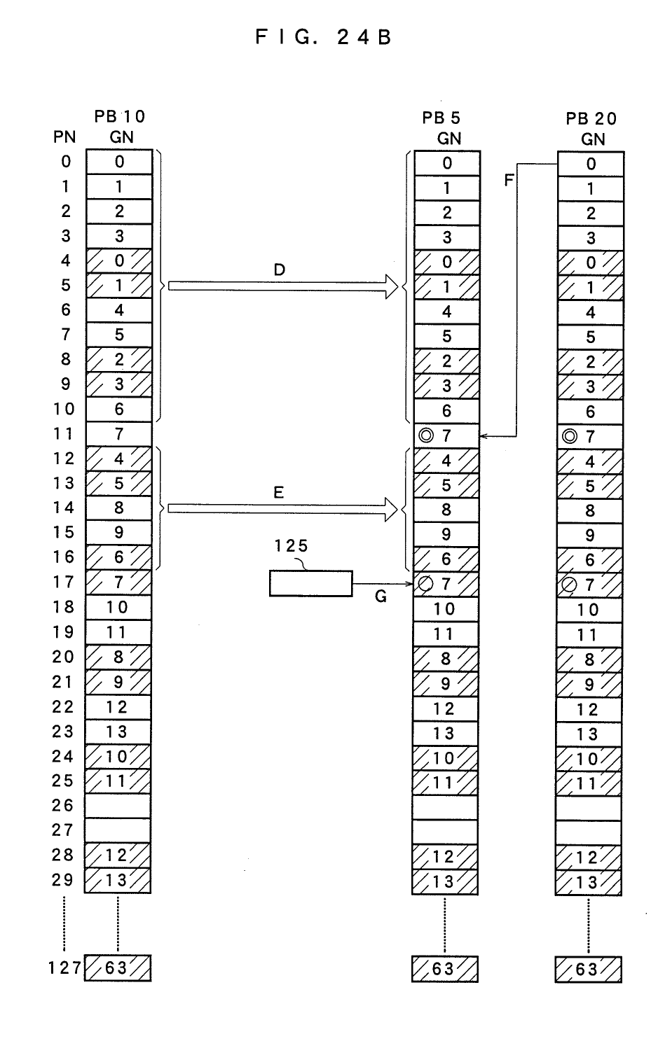

In a case of writing data into the second page in the present embodiment, before the writing, data stored in the first page corresponding to the second page is temporarily stored in another physical block. For example, as shown in FIG. 24A, when data is written into the page 17 (an arrow C), the data is temporarily stored in the save area in a physical block PB20, namely, the leading page (an arrow B). And if a flash error occurs, processing of restoring the error is performed. That is, as shown in FIG. 24B, in addition to the above-mentioned copy processing (arrows D, E) and retry processing (arrow G), repair processing is performed. In the repair processing, data written into the save area of the physical block PB20 for save is written back into a page 11 as the repair page in the physical block PB50 as shown by the arrow F in FIG. 14B.

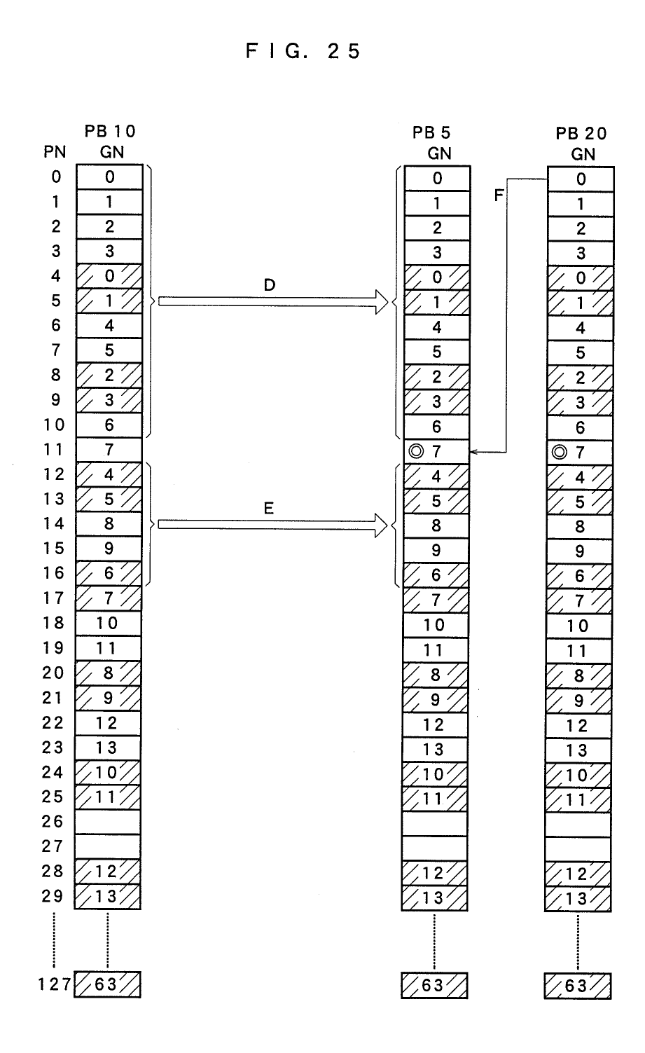

In the event that trouble occurs due to power shutdown, to solve the trouble, as shown in FIG. 25, in addition to the above-mentioned copy processing (the arrows D, E), repair processing is performed. The repair processing is for writing back the data written into the save area of the physical block PB20 into the physical block PB5 as shown by the arrow F. The other operations are similar to those in the first embodiment. Thus, data can be saved by using only the nonvolatile memory without separately providing a save memory, thereby improving reliability in the case of using the multi-level flash memory.

In each of the above-mentioned embodiments, the nonvolatile memory 110 is a memory in which each memory cell holds data striding over two pages, however, the present invention can be also applied to a memory which holds data striding over three pages. The single-level NAND flash memory, for example, in which the memory cell is closed in the page may be used as the nonvolatile memory 110. In this case, the page information instruction part 153 returns the page 0 as the related page number to the related page identification part 152 on every occasion, thereby masking an execution of the repair processing. The present invention is not limited to the above-mentioned embodiments.

### INDUSTRIAL APPLICABILITY

The memory controller, nonvolatile memory device and nonvolatile memory system according to the present invention can improve reliability of an apparatus using a nonvolatile memory such as a multi-level NAND flash memory in which each memory cell holds data over multiple pages therein. The present invention can be applied to a recording medium for portable AV equipments such as a still image recording and reproduction device and moving image recording and reproduction device or a portable communication equipment such as a mobile phone.

1. A memory controller for writing data given from outside into a nonvolatile memory which is composed of a plurality of pages and in which each memory cell holds data of a plurality of pages composing a group therein and for reading data from the nonvolatile memory comprising:
an error restoration part for restoring an error occurring in data stored in another page belonging to the same group as an error occurrence page with a write error, wherein
said error restoration part, given that a page which belongs to the same group as a current page to which data is written and stores data therein is a related page, reads related data stored in said related page, temporarily stores the related data in a save area prior to writing of the data, and restores an error using the related data at an occurrence of the error.

2. The memory controller according to claim 1 comprising:
an error page identification part for identifying, when an error occurs during writing data in a certain page in said nonvolatile memory, a page in which the error occurs, wherein
said error page identification part includes:
a power shutdown determination part for determining an occurrence of power shutdown; and
a memory trouble determination part for determining an occurrence of trouble in said nonvolatile memory.

3. The memory controller according to claim 1, wherein
said error restoration part further comprises:
a page information instruction part for outputting page information on pages composing the same group in said nonvolatile memory;
a related page identification part for identifying a related page based on said current page and page information outputted from said page information instruction part; and
a substitute and repair processing part for repairing data stored in said related page by using said related data at an occurrence of an error.

4. The memory controller according to claim 3, wherein
said nonvolatile memory is composed of a plurality of physical blocks,
said substitute and repair processing part performs copy processing for copying data written into an errorless page in a physical block during writing to another invalid physical block in said nonvolatile memory, repair processing for rewriting related data which is miswritten and held in said save area into a repair page of said invalid physical block, and retry processing for rewriting miswritten data in the physical block into said invalid physical block.

5. The memory controller according to claim 3, wherein
said nonvolatile memory is composed of multiple physical blocks,
said substitute and repair processing part performs copy processing for copying data written into an errorless page in a physical block during writing to another invalid physical block in said nonvolatile memory and repair processing for rewriting related data which is miswritten and held in said save area into a repair page of said invalid physical block, and
said error restoration part saves the related data in a nonvolatile storage area.

6. The memory controller according to claim 3, wherein
said error restoration part has a nonvolatile save memory which saves the related data therein.

7. The memory controller according to claim 6, wherein
said save memory is a nonvolatile RAM.

8. The memory controller according to claim 7, wherein
said nonvolatile RAM is composed of any one of a ferroelectric memory (FeRAM), Magnetoresistive Random Access Memory (MRAM), Ovonics Unified Memory (OUM), and Resistive RAM (RRAM).

9. A nonvolatile memory device comprising:
a nonvolatile memory composed of a plurality of pages in which each memory cell holds data of a plurality of pages composing a group therein; and
a memory controller for writing data given from outside and for reading data from the nonvolatile memory, wherein
said memory controller includes:
an error restoration part for restoring an error occurring in data stored in another page belonging to the same group as an error occurrence page with a write error, and
said error restoration part, given that a page which belongs to the same group as a current page to which data is written and stores data therein is a related page, reads related data stored in said related page, temporarily stores the related data in a save area prior to writing of the data, and restores an error using the related data at an occurrence of the error.

10. The nonvolatile memory device according to claim 9, wherein
said memory controller includes:
an error page identification part for identifying, when an error occurs during writing data in a certain page in said nonvolatile memory, a page in which the error occurs, and
said error page identification part includes:
a power shutdown determination part for determining an occurrence of power shutdown; and
a memory trouble determination part for determining an occurrence of trouble in said nonvolatile memory.

11. The nonvolatile memory device according to claim 9, wherein
said error restoration part further comprises:
a page information instruction part for outputting page information on pages composing the same group in said nonvolatile memory;
a related page identification part for identifying a related page based on said current page and page information outputted from said page information instruction part; and
a substitute and repair processing part for repairing data stored in said related page by using said related data at an occurrence of an error.

12. The nonvolatile memory device according to claim 11, wherein
said nonvolatile memory is composed of a plurality of physical blocks,
said substitute and repair processing part performs
copy processing for copying data written into an errorless page in a physical block during writing to another invalid physical block in said nonvolatile memory, repair processing for rewriting related data which is miswritten and held in said save area into a repair page of said invalid physical block, and retry processing for rewriting miswritten data in the physical block into said invalid physical block.

13. The nonvolatile memory device according to claim 11, wherein
said nonvolatile memory is composed of multiple physical blocks,
said substitute and repair processing part performs copy processing for copying data written into an errorless page in a physical block during writing to another invalid physical block in said nonvolatile memory and repair processing for rewriting related data which is miswritten and held in said save area into a repair page of said invalid physical block, and
said error restoration part saves the related data in a nonvolatile storage area.

14. The memory controller according to claim 11, wherein
said error restoration part has a nonvolatile save memory which saves the related data therein.

15. The nonvolatile memory device according to claim 14, wherein
said save memory is a nonvolatile RAM.

16. The nonvolatile memory device according to claim 15, wherein
said nonvolatile RAM is composed of any one of a ferroelectric memory (FeRAM), Magnetoresistive Random Access Memory (MRAM), Ovonics Unified Memory (OUM), and Resistive RAM (RRAM).

17. A nonvolatile memory system comprising:
an access device; and
a nonvolatile memory device, wherein
said access device sends a write command and data to said nonvolatile memory device, and
said nonvolatile memory device includes:
a nonvolatile memory composed of a plurality of pages in which each memory cell holds data of a plurality of pages composing a group therein; and
a memory controller for writing data given from outside and for reading data from the nonvolatile memory,
said memory controller includes:
an error restoration part for restoring an error occurring in data stored in another page belonging to the same group as an error occurrence page with a write error, and
said error restoration part, given that a page which belongs to the same group as a current page to which data is written and stores data therein is a related page, reads related data stored in said related page, temporarily stores the related data in a save area prior to writing of the data, and restores an error using the related data at an occurrence of the error.

18. The nonvolatile memory system according to claim 17, wherein
said memory controller includes:
an error page identification part for identifying, when an error occurs during writing data in a certain page in said nonvolatile memory, a page in which the error occurs, and
said error page identification part includes:
a power shutdown determination part for determining an occurrence of power shutdown; and
a memory trouble determination part for determining an occurrence of trouble in said nonvolatile memory.

19. The nonvolatile memory system according to claim 17, wherein
said error restoration part further comprises:
a page information instruction part for outputting page information on pages composing the same group in said nonvolatile memory;
a related page identification part for identifying a related page based on said current page and page information outputted from said page information instruction part; and
a substitute and repair processing part for repairing data stored in said related page by using said related data at an occurrence of an error.

20. The nonvolatile memory system according to claim 19, wherein
said nonvolatile memory is composed of a plurality of physical blocks,
said substitute and repair processing part performs copy processing for copying data written into an errorless page in a physical block during writing to another invalid physical block in said nonvolatile memory, repair processing for rewriting related data which is miswritten and held in said save area into a repair page of said invalid physical block, and retry processing for rewriting miswritten data in the physical block into said invalid physical block.

21. The nonvolatile memory system according to claim 19, wherein
said nonvolatile memory is composed of multiple physical blocks,
said substitute and repair processing part performs copy processing for copying data written into an errorless page in a physical block during writing to another invalid physical block in said nonvolatile memory and repair processing for rewriting related data which is miswritten and held in said save area into a repair page of said invalid physical block, and
said error restoration part saves the related data in a nonvolatile storage area.

22. The memory controller according to claim 19, wherein
said error restoration part has a nonvolatile save memory which saves the related data therein.

23. The nonvolatile memory system according to claim 22, wherein
said save memory is a nonvolatile RAM.

24. The nonvolatile memory system according to claim 23, wherein
said nonvolatile RAM is composed of any one of a ferroelectric memory (FeRAM), Magnetoresistive Random Access Memory (MRAM), Ovonics Unified Memory (OUM), and Resistive RAM (RRAM).

25. A data writing method for writing data given from outside into a nonvolatile memory which is composed of a plurality of pages and in which each memory cell holds data of a plurality of pages composing a group therein, comprising a step of:
restoring errors occurring in data stored in other pages belonging to the same group of an error page in which a writing error occurred, wherein
said error restoration step includes, given that a page which belongs to the same group as a current page to which data is written and stores data therein is a related page, reading related data stored in said related page, temporarily storing the related data in a save area prior to writing of the data, and restoring an error using the related data at an occurrence of the error.

26. The data writing method according to claim 25, wherein
said error restoration step includes outputting page information on pages composing the same group, identifying a related page based on said current page and page information, and repairing data stored in said related page by using said related data at an occurrence of an error.

27. The data writing method according to claim 26, wherein
said nonvolatile memory is composed of a plurality of physical blocks, and
said substitute and repair processing step includes performing copy processing for copying data written into an errorless page in a physical block during writing to another invalid physical block in said nonvolatile memory, repair processing for rewriting related data which is miswritten and held in said save area into a repair page of said invalid physical block, and retry processing for rewriting miswritten data in the physical block into said invalid physical block.

28. The data writing method according to claim 26, wherein
said nonvolatile memory is composed of multiple physical blocks,
said substitute and repair processing step includes performing copy processing for copying data written into an errorless page in a physical block during writing to another invalid physical block in said nonvolatile memory and repair processing for rewriting related data which is miswritten and held in said save area into a repair page of said invalid physical block, and
said save area is a nonvolatile area.
